(19) United States
(12) Patent Application Publication
(10) Pub. No.: US 2015/0070348 A1
(43) Pub. Date: Mar. 12, 2015

(54) Graphical System and Method of Use

(71) Applicant: Guardian Research Technologies, LLC, Amarillo, TX (US)

(72) Inventors: Teresa HAYES, Amarillot, TX (US); Roger HAYES, Amarillo, TX (US); Shannon Lance Warren, Cypress, TX (US); Robert Mills, Canyon, TX (US)

(21) Appl. No.: 14/325,361

(22) Filed: Jul. 7, 2014

Related U.S. Application Data
(60) Provisional application No. 61/843,378, filed on Jul. 7, 2013.

(51) Int. Cl. G06T 11/20; G06T 15/08

(52) U.S. Cl. CPC G06T 11/206; G06T 15/08
USPC 345/419; 345/440

(57) ABSTRACT

A graphical system is disclosed comprising: a lofted graph comprising a one or more slices arranged on a path. Said one or more slices connected to one another by lofting them together. Each of said one or more slices separated from one another by a cycle distance. A one or more period values each associated with a one or more cycle values. Said one or more slices representing a one or more values at said cycle value. Said one or more values comprising a datum at said cycle value.

### CROSS-REFERENCE TO RELATED APPLICATIONS

This application claims the benefit of provisional U.S. Patent Application No. 61/843,378, filed Jul. 7, 2013.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure relates generally to a graphical system and method of use. No known inventions and patents, taken either singularly or in combination, is seen to describe the instant disclosure as claimed.

### BRIEF SUMMARY OF THE INVENTION

A graphical system and a method of use thereof are disclosed.

Said graphical system comprising: a lofted graph comprising a one or more slices arranged on a path. Said one or more slices connected to one another by lofting them together. Each of said one or more slices separated from one another by a cycle distance. A one or more period values each associated with a one or more cycle values. Said one or more slices representing a one or more values at said cycle value. Said one or more values comprising a datum at said cycle value.

A method of using a graphical system comprising: rending a lofted graph along a path with a one or more slices; and rendering said one or more slices from a one or datum at a cycle value.

### BRIEF DESCRIPTION OF THE SEVERAL VIEWS OF THE DRAWING

FIGS. 1A, 1B, 1C and 1D illustrate a table comprising a data input, a radar chart, a radar chart and a 3-axis cyclical data graphic.

FIGS. 2A, 2B, 2C, 2D and 2E illustrate a 2-dimentional arrangement of said one or more slices, a rendering of a 3-dimentional object made up of said one or more slices, a perspective overview of a linear loft, an elevated front view of said linear loft, and a perspective overview of a linear loft with a one or more hidden lines displayed.

FIGS. 3A, 3B, 3C and 3D illustrate a data input table, a one or more slices, a perspective overview of a linear loft, and an elevated front view of said linear loft.

FIGS. 4A, 4B and 4C illustrate a data input table, a radar chart and a radar chart.

FIGS. 4D, 4E and 4F illustrate an elevated side view, an elevated front view and a perspective overview of a linear loft.

FIGS. 5A, 5B and 5C illustrate a perspective overview of a helical loft, said helical loft in a wireframe view and an elevated front view of said helical loft.

FIG. 6 illustrates a flow diagram comprising a first step, a second step, a third step and a fourth step.

FIG. 7 illustrates a flow diagram comprising said first step, said second step, and a third step.

FIG. 8 illustrates a flow diagram comprising said first step, said second step, a third step and a fourth step.

FIG. 9 illustrates a flow diagram comprising said first step, said second step, and a third step.

FIG. 10 illustrates a flow diagram comprising said first step.

FIG. 11 illustrates a flow diagram comprising said first step.

FIG. 12 illustrates a flow diagram 1200 comprising said first step 602, said second step 604, and a third step 1202.

### DETAILED DESCRIPTION OF THE INVENTION

Described herein is a Graphical System and Method of Use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

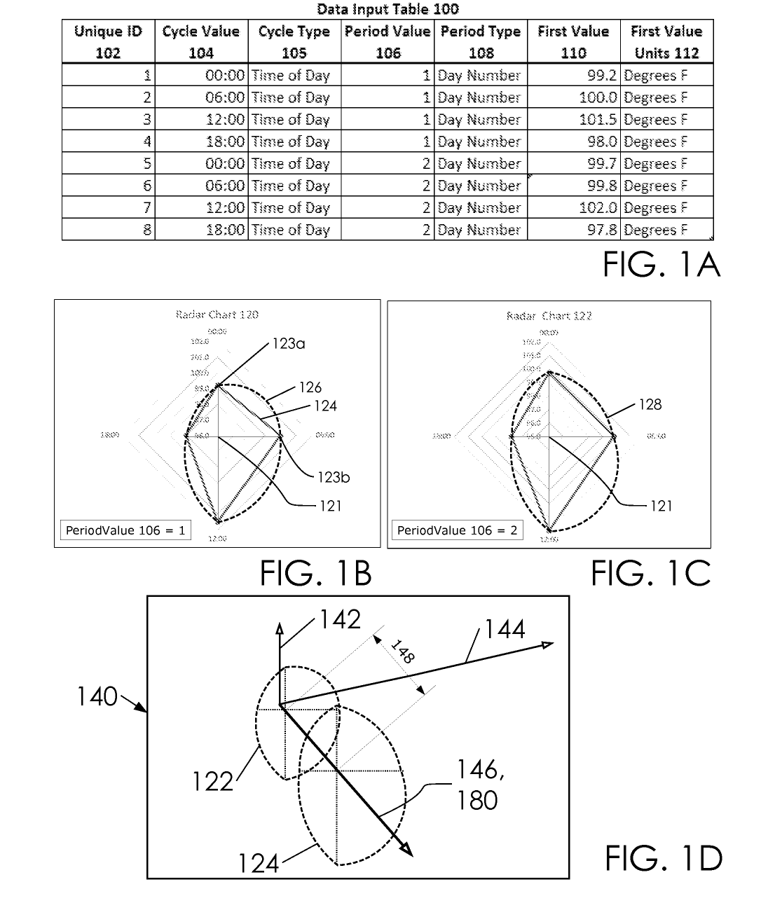

FIGS. 1A, 1B, 1C and 1D illustrate a table comprising a data input 100, a radar chart 120, a radar chart 122 and a 3-axis cyclical data graphic 140. In one embodiment, said data input 100 can comprise a table (such as a database table) comprising one or more data fields. In one embodiment, said data input 100 can comprise a unique ID 102 to ensure that each data entry is uniquely identifiable. In one embodiment, said data input 100 can also comprise a cycle value 104, a cycle type 105, a period value 106, a period type 108, a first value 110 and a first value units 112. In one embodiment, said cycle type 105 can describe the data type of said cycle value 104, and said period type 108 can describe the data type of said a period value 106. In one embodiment, each of said a period value 106 can have a repeating cycle which are described by the data of said cycle value 104. In one embodiment, said first value 110 can be a value recorded at said cycle value 104 and said a period value 106.

For example, in one embodiment, said cycle value 104 can be one or more times of day associated with said a period value 106 which can be a day number. As illustrated in FIG. 1A, a temperature (such as an animal's internal temperature) can be tracked with said first value 110 at different times.

In one embodiment, datum in said data input 100 can be charted on a one or more radar charts, such as said radar chart 120 and/or said radar chart 122. In one embodiment, said one or more radar charts can comprise one radar chart for each of said a period value 106. For example, in one embodiment, said radar chart 120 can represent datum associated with said data input 100 where said a period value 106 equals one (1), and said radar chart 122 where said a period value 106 equals two (2). In one embodiment, said one or more radar charts can comprise said first value 110 arranged radially about an axis 121 with said cycle value 104 defining a one or more positions around said axis 121 at a distance from said axis 121 defined by said first value 110, as illustrated. In one embodiment, said first value 110 for each of said a period value 106 can be plotted on said one or more radar charts with a one or more data points (comprising, in one embodiment, a first point 123a and a second point 123b). In one embodiment, a one or more lines (such as a first line 124) can be drawn between said one or more data points. In one embodiment, a one or more rounded slices can be drawn around said one or more data points. In one embodiment, said rounded slices can comprise rounded edges arranged around said one or more lines, as illustrated. In one embodiment, said one or more slices can comprise a first slice 126 for radar chart 120 and a second slice 128 for said radar chart 122.

In one embodiment, said 3-axis cyclical data graphic 140 can comprise a three axes comprising a first axis 142, a second axis 144 and a third axis 146. In one embodiment, said one or more slices can be arranged on said 3-axis cyclical data graphic 140. In one embodiment, arranging said one or more slices on said 3-axis cyclical data graphic 140 can comprise aligning said axis 121 of each of said one or more slices with one of said three axes and separating each of said one or more slices by a cycle distance 148.

In one embodiment, each among said one or more slices can be arranged along a slice path (here said third axis 146 comprises said slice path). In one embodiment, said slice path can comprise a straight line. In one embodiment, said one or more slices can be arranged in a row along said slice path.

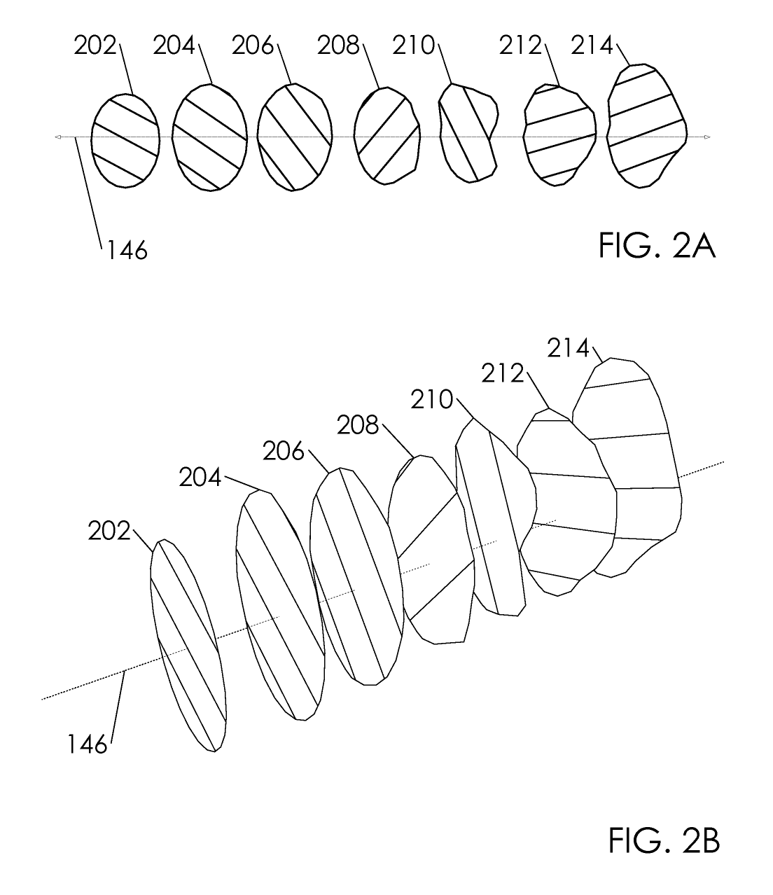

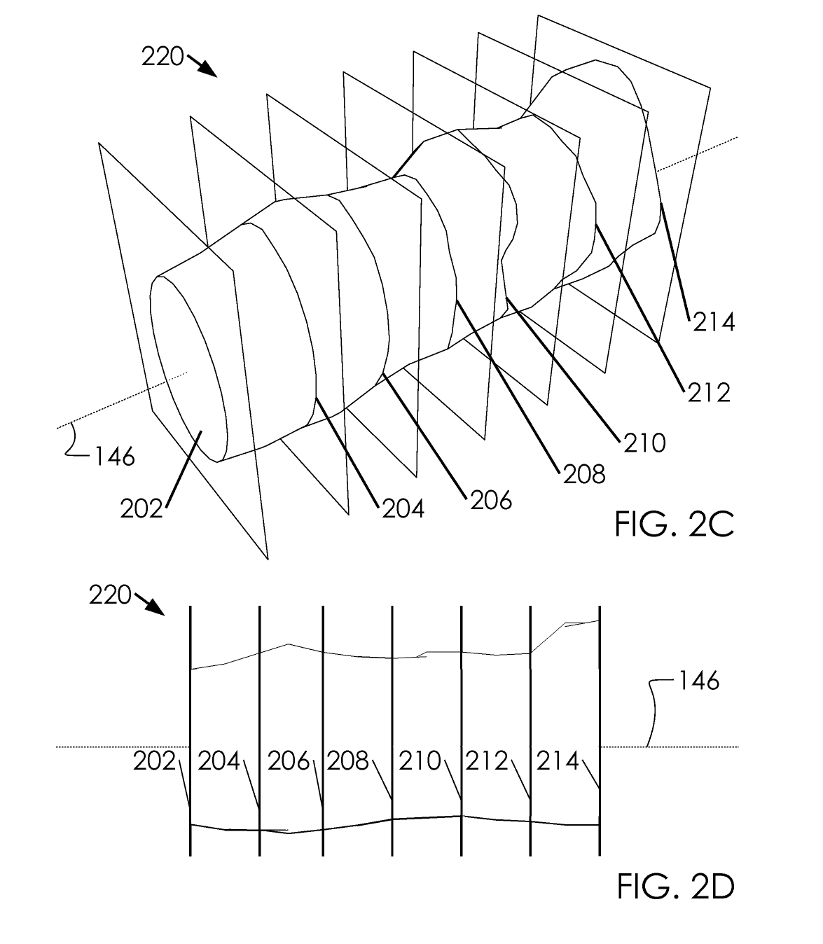

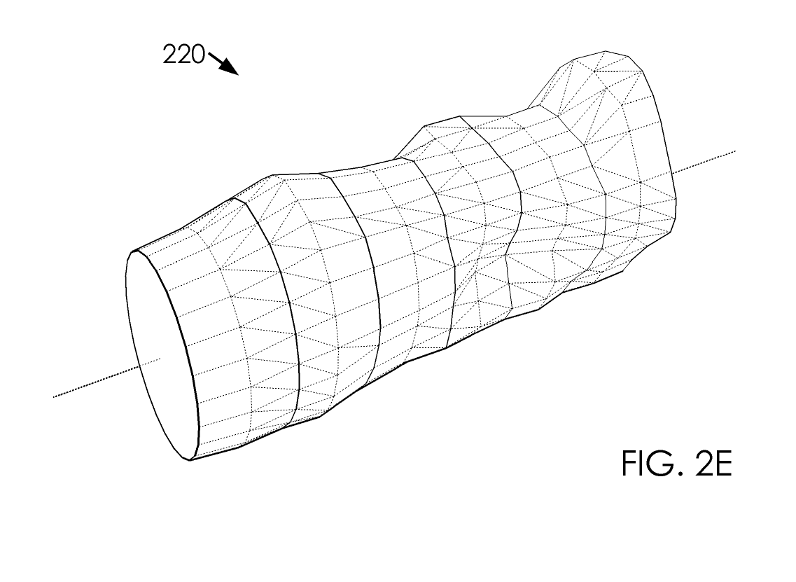

FIGS. 2A, 2B, 2C, 2D and 2E illustrate a 2-dimentional arrangement of said one or more slices, a rendering of a 3-dimentional object made up of said one or more slices, a perspective overview of a linear loft 220, an elevated front view of said linear loft 220, and a perspective overview of a linear loft 220 with a one or more hidden lines 222 displayed.

Space between any two datum (such as said first slice 126 and said second slice 128) can be filled in by geometric “lofting” where the interim spaces are filled using either moving averages or polynomial averaging. In one embodiment, a loft is a variant of a wireframe volume of the 3-d object, a technique used in 3d modeling such as 3D Studio Max, Creo*, SolidWorks, and NX. It's developed from planar sections spaced along an approximate path. Consider lofting in boat building to visualize the process, the planar sections are the boat ribs spaced along its length. The planking then forms the 3D volume as it develops a smooth skin between the ribs. Thus, the graphical system and method of use thereof disclosed herein can comprise a lofted graph arranged in a linear fashion (as illustrated here) and/or a helical fashion (as illustrated infra).

In one embodiment, said one or more slices can comprise a first slice 202, a second slice 204, a third slice 206, a fourth slice 208, a fifth slice 210, a sixth slice 212 and a seventh slice 214. In one embodiment, said one or more slices can be arranged on said third axis 146, as discussed supra. In one embodiment, each among said one or more slices can comprise a polygon rendered from said one or more radar charts.

In one embodiment, said one or more slices can be rendered as a 3-dimentional object generally having a cylindrical shape, as shown in FIGS. 2C-2D. In one embodiment, said one or more slices can be rendered about said slice path, which can comprise a linear path.

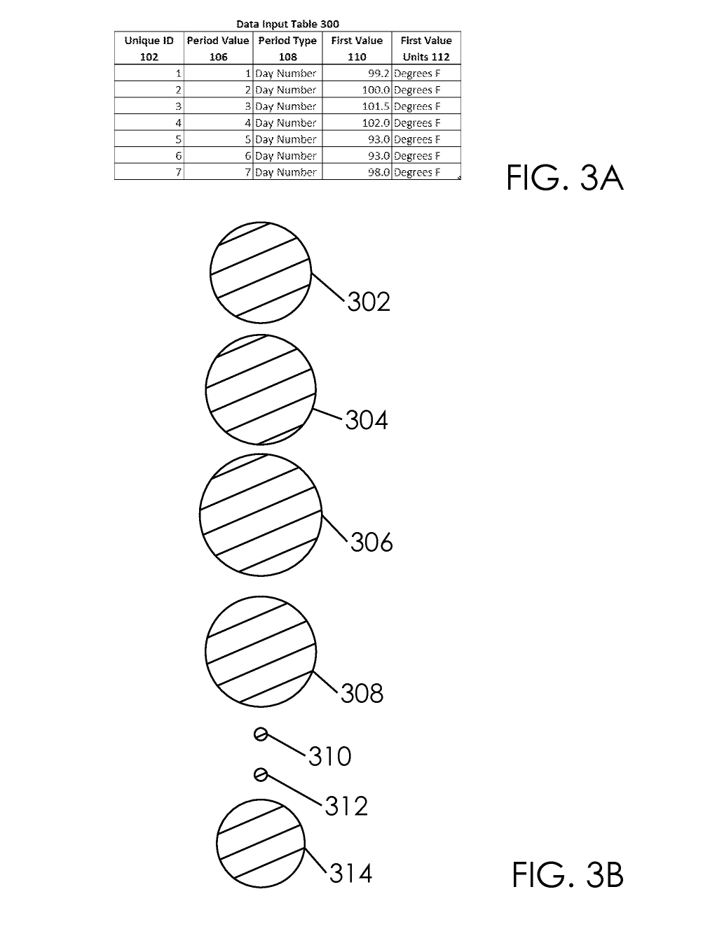

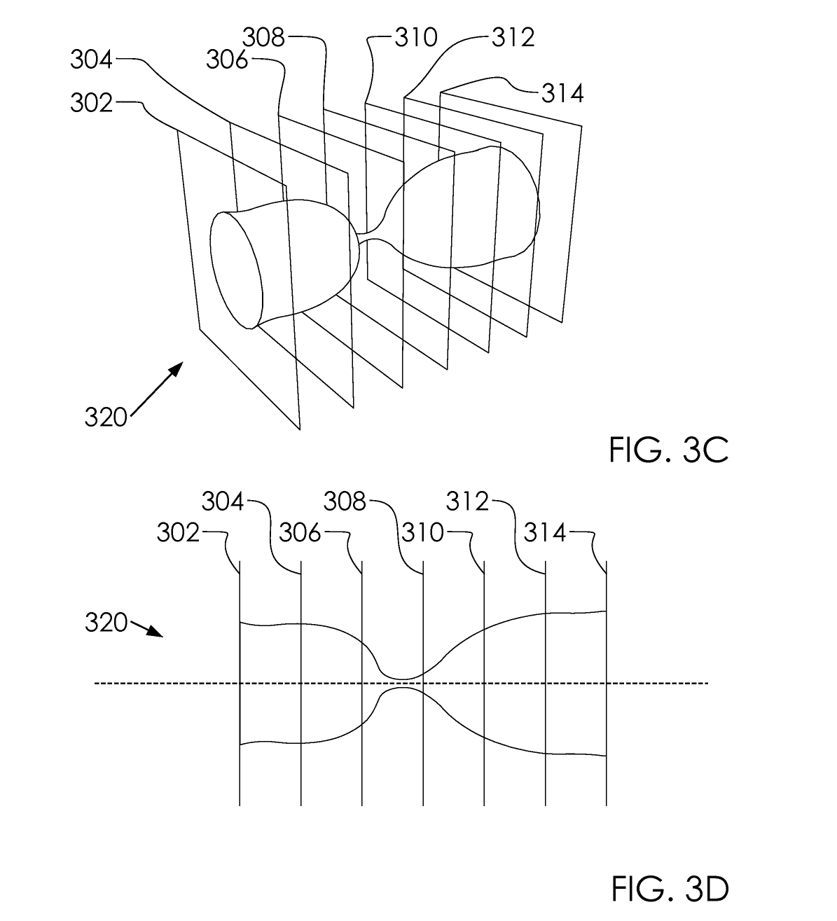

FIGS. 3A, 3B, 3C and 3D illustrate a data input table 300, a one or more slices, a perspective overview of a linear loft 320, and an elevated front view of said linear loft 320. In one embodiment, said linear loft can comprise a one or more circular cross sections generated from said first value 110 associated with said period value 106. In one embodiment, said one or more slices can comprise a first slice 302, a second slice 304, a third slice 306, a fourth slice 308, a fifth slice 310, a sixth slice 312 and a seventh slice 314.

In one embodiment, said data input table 300 can be useful for identifying the effects of an effect of a medication. For example, as illustrated in FIG. 3A, said first value 110 can comprise a body temperature of an animal at a fixed time over a course of several days. Wherein, said first slice 302 through said third slice 306 can comprise a healthy animal, said fourth slice 308 can comprise a physical reaction to a medication given during said first slice 302, and said fifth slice 310 through said seventh slice 314 can comprise a series of typical afternoons after the animal has recovered.

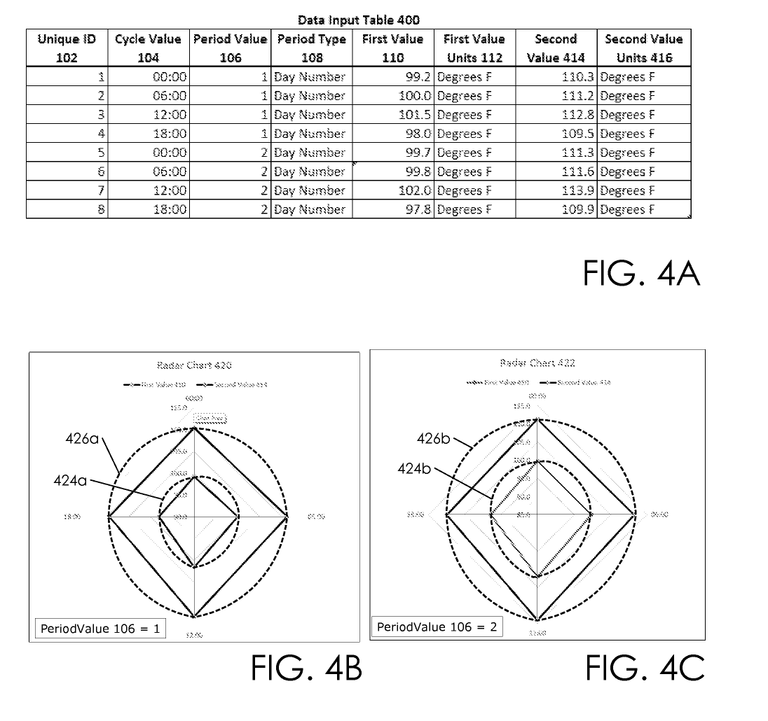

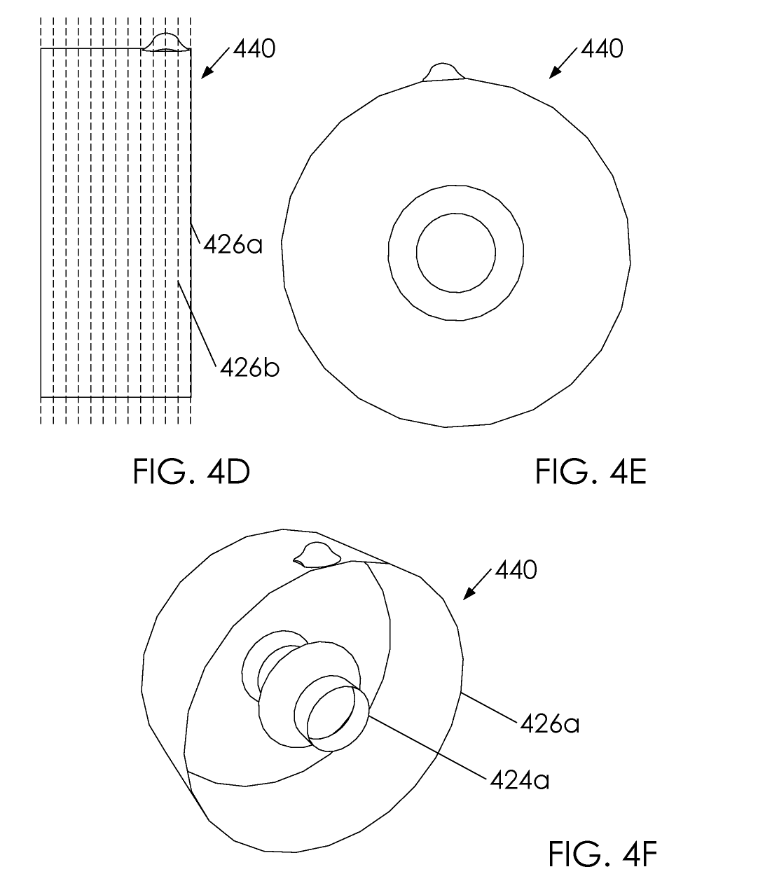

FIGS. 4A, 4B and 4C illustrate a data input table 400, a radar chart 420 and a radar chart 422. In one embodiment, said data input table 400 can comprise said unique ID 102, said cycle value 104, said a period value 106, said period type 108, said first value 110, said first value units 112, a second value 414, and a second value units 416.

In one embodiment, said graphical system disclosed herein can accommodate a one or more datum in one graphic. In one embodiment, said one or more datum can comprise said first value 110 and a second value 414. In one embodiment, said first value 110 can be expressed in a first value first slice 424a and a first value second slice 424b; and said second value 414 can be expressed in a second value first slice 426a and a second value second slice 426b, as illustrated.

FIGS. 4D, 4E and 4F illustrate an elevated side view, an elevated front view and a perspective overview of a linear loft 440. In one embodiment, said linear loft 440 can display said first value first slice 424a nested within said second value first slice 426a.

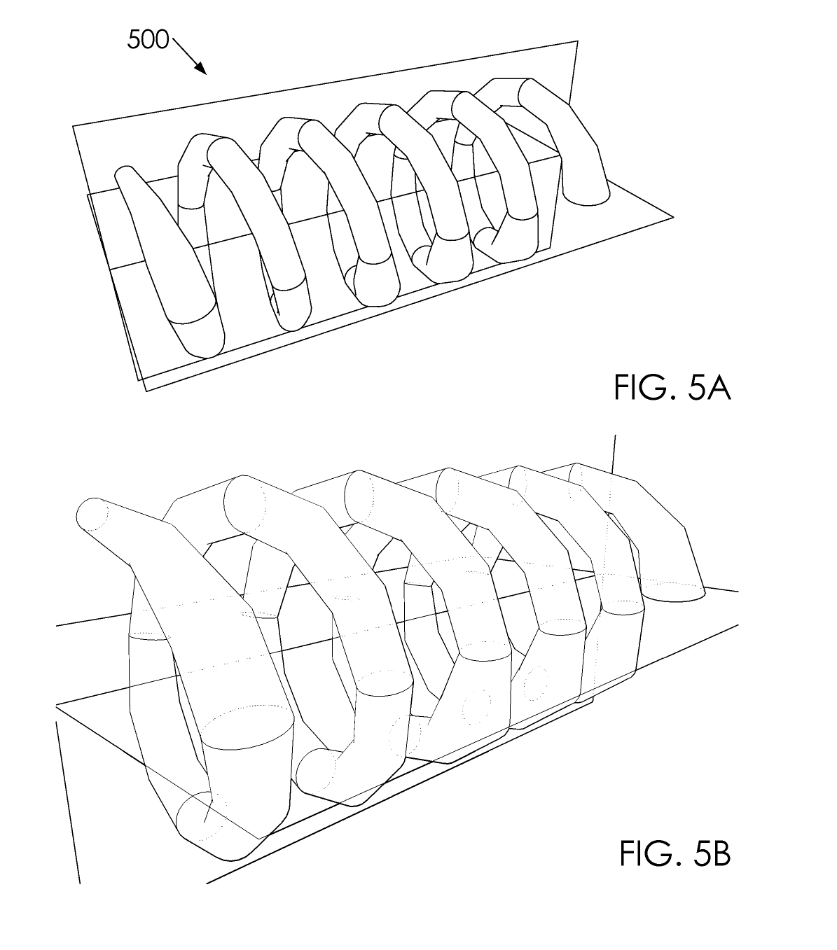

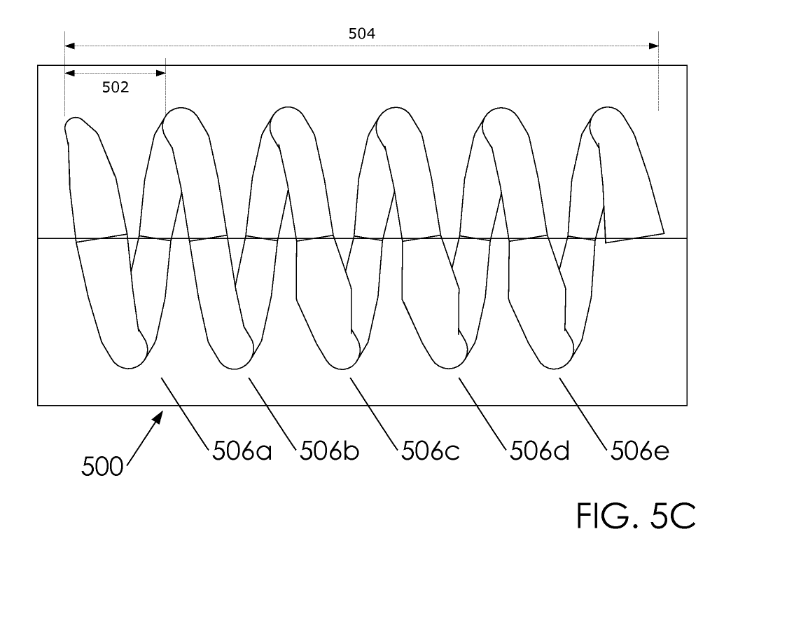

FIGS. 5A, 5B and 5C illustrate a perspective overview of a helical loft 500, said helical loft 500 in a wireframe view and an elevated front view of said helical loft 500. In one embodiment, said linear loft 220 (or any of the other among said linear lofts, supra) can be wrapped around a helix. According to FIGS. 5A-5B this demonstrates different aspects of a single graph.

In one embodiment, said helical loft 500 can be formed with three basic elements; viz., (i) said one or more slices representing one or more geometric shapes in profile of a form (which can be a cylinder, noted by a simple Circle), (ii) the distance between like positions (illustrated here as a distance 502) on said helical loft 500 or the number of coils per a length 504, and (iii) a number of coils (illustrated here as a first coil 506a, a second coil 506b, a third coil 506c, a fourth coil 506d and a fifth coil 506e).

In one embodiment, said helical loft 500 can be formed by wrapping one of said one or more linear lofts (disclosed above) around an axis 506. Said helical loft 500 can be arranged around a thread (not illustrated) which can comprise a simple line adjacent to and drawn through the series of planes. In one embodiment, a one or more values (such as said first value 110) are placed on each of said one or more slices (corresponding to time) with the apex common to said thread. In one embodiment, a series of said slices can be spaced and aligned to said thread and then converted, via “lofting” to a linear graphic representing the measurements over time. In one embodiment, said thread is then “wound” into a helical shape, each coil can comprise a 0-degree point that represents a type of cyclic repetition; I.e., an hour, a day, a heartbeat, etc. In one embodiment, the resulting geometry is a 3-d parametric solid form that represents a form where one can see time, value, repetition, and series, kept organized into a cyclic order. In one embodiment, said slice path 180 can comprise a helical path 520.

With said helical loft 500 single measurement type (such as said first value 110) is represented—hereafter the functions Thread—being a single representation of a single metric. In one embodiment, multiple measurements winding through the same time period would form a set of multiple Threads progressing together through time or a “Cord”. In one embodiment, said cord can comprise multiple threads forming or representing a single shape or element.

In one embodiment, said threads forming a non-twisted or woven Cord, wind through the helix (or parent form) in parallel, they represent two actual independent shapes (measurements) simply moving through time together (not illustrated here).

In one embodiment, if said threads interact, via winding together, weaving, or like interaction, the actual movement of one of said thread against another of said thread represents such items as positional exchange, phase shift, ordination, etc.

In one embodiment, multiplicities of said thread form a rope, a multiplicity of ropes moving through time together for a cable. Again the interaction of multiple Cables moving through time in parallel simply represent sets of measurements being measured in like period. The Interaction of Cables moving through time represent such relationships as exchange, phase shift, interreplacement, modal shift, ordination, etc.

In one embodiment, a Multiplicity of Cables moving through time together would be called a “Cluster”.

FIG. 5A-5C demonstrates a complete graph for a (a. single value measurement, (b. proceeding through a constant time period as follows: a. Each coil represents a 24-hour timer period with; b. Top position=12:noon; c. 3:00 position represents 6:00 pm; d. 6:00 position represents midnight; e. 9:00 position represents 6:00 am.; I.e., The complete coil segment represents a division of 24/6=4 segments.; f. Values drive the diameter of the actual helix's Thread Profile; g. spacing between coils is of no particular value in these examples. (explained later); h. Note that samples of 4/24 hours demonstrate that there are 2 planes, at 90-deg's, required to graph the circles (of whatever shape forms the coil profile); i. The Noon and Midnight “Thread Profiles” exist on the same plane where the center “Wire” from which the helix was modeled positions each of them. (Remembering that a helix is a line wound angularly or non-intersectingly around a cylinder. The helix center Wire represents the circle that marks the diameter of the helix. Pitch and direction are determined with other factors discussed later; (and) j. The 6:00 a and 6:00 p Thread Sketches exist on the same plane, where the center Wire of the helix places them diametrically opposite from each other.

In one embodiment, the 1st 6-hour period highlighted yielding: a. visual of the starting and ending (visual) indicia of values with NO values stated. One can only see the relationship between them; b. visual indication of the progression of the trend; c. Since only two values are considered (start/end), it is NOT apparent what happened in between. This is a simple product of sampling resolution .vs. natural flow of lofted surfaces.

In one embodiment, the 6:00 pm through Midnight segment—OR—“Segment 2”—OR—“Day 1, Quarter 2.”

In one embodiment, of the intrinsic features that form the graphic: a. The measurement Profiles that are forming the coil's Thread node segments, I.e., the circles that demonstrate the diameter of the wire at each intervals location; b. In this example, each nodes measurement is dimensioned by the actual measurement values of each point in time; c. Reverse-assembling the coil will demonstrate the actual (and lofted) measurements at any point in time with the key points of 0 (top), 90,180,270-degrees being actual measurements and all other variations being assumed measurements.

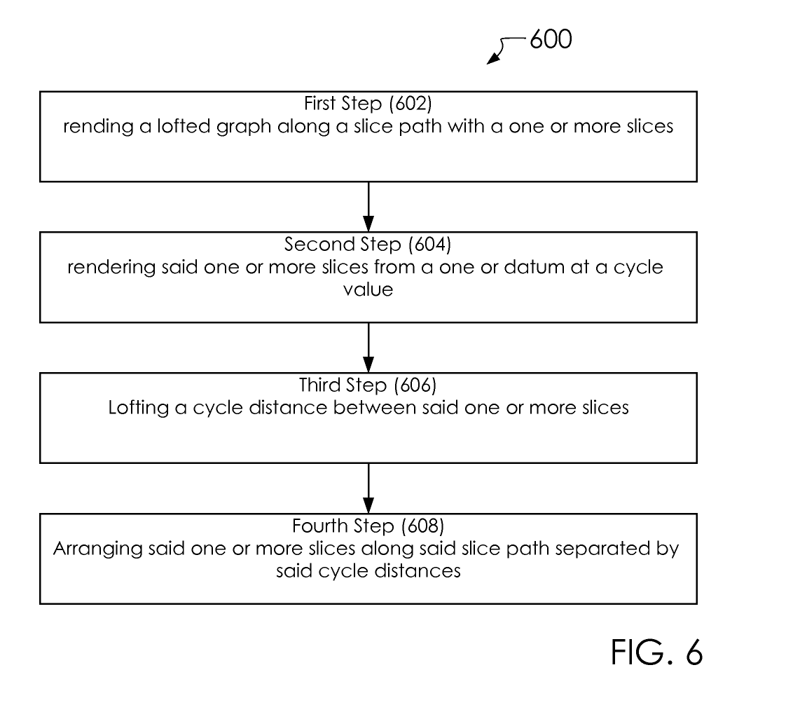

FIG. 6 illustrates a flow diagram 600 comprising a first step 602, a second step 604, a third step 606 and a fourth step 608. In one embodiment, said first step 602 can comprise rending a lofted graph along a slice path with a one or more slices. In one embodiment, said second step 604 can comprise rendering said one or more slices from a one or datum at a cycle value. In one embodiment, said third step 606 can comprise lofting a cycle distance between said one or more slices. In one embodiment, said fourth step 608 can comprise arranging said one or more slices along said slice path separated by said cycle distances.

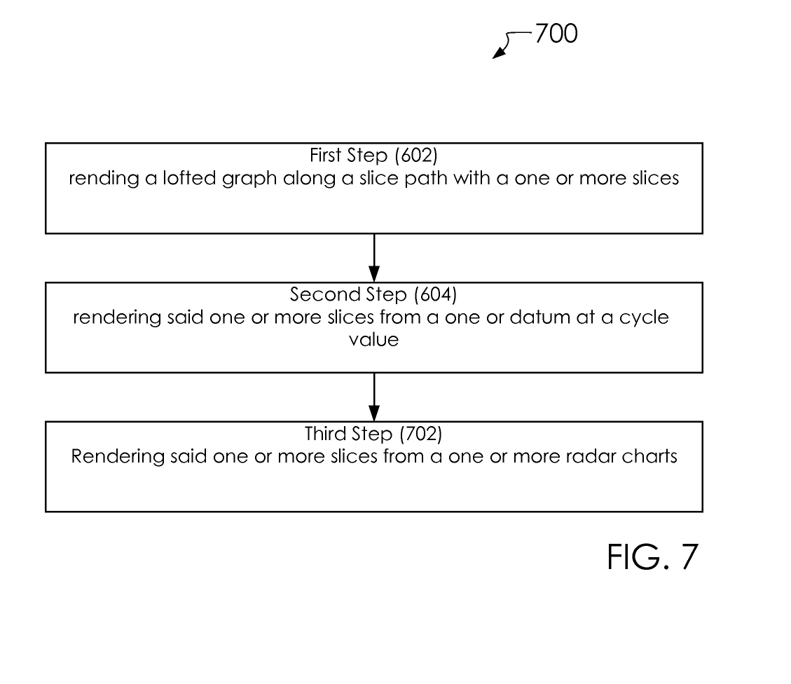

FIG. 7 illustrates a flow diagram 700 comprising said first step 602, said second step 604, and a third step 702. In one embodiment, said third step 702 can comprise rendering said one or more slices from a one or more radar charts.

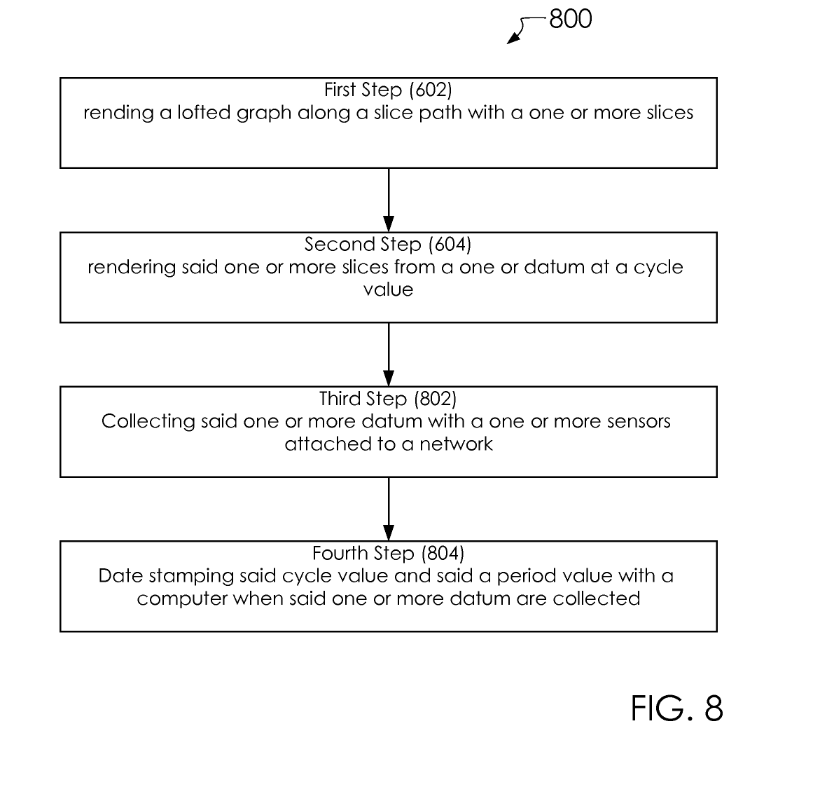

FIG. 8 illustrates a flow diagram 800 comprising said first step 602, said second step 604, a third step 802 and a fourth step 804. In one embodiment, said third step 802 can comprise collecting said one or more datum with a one or more sensors attached to a network. In one embodiment, said fourth step 804 can comprise date stamping said cycle value and said a period value with a computer when said one or more datum are collected.

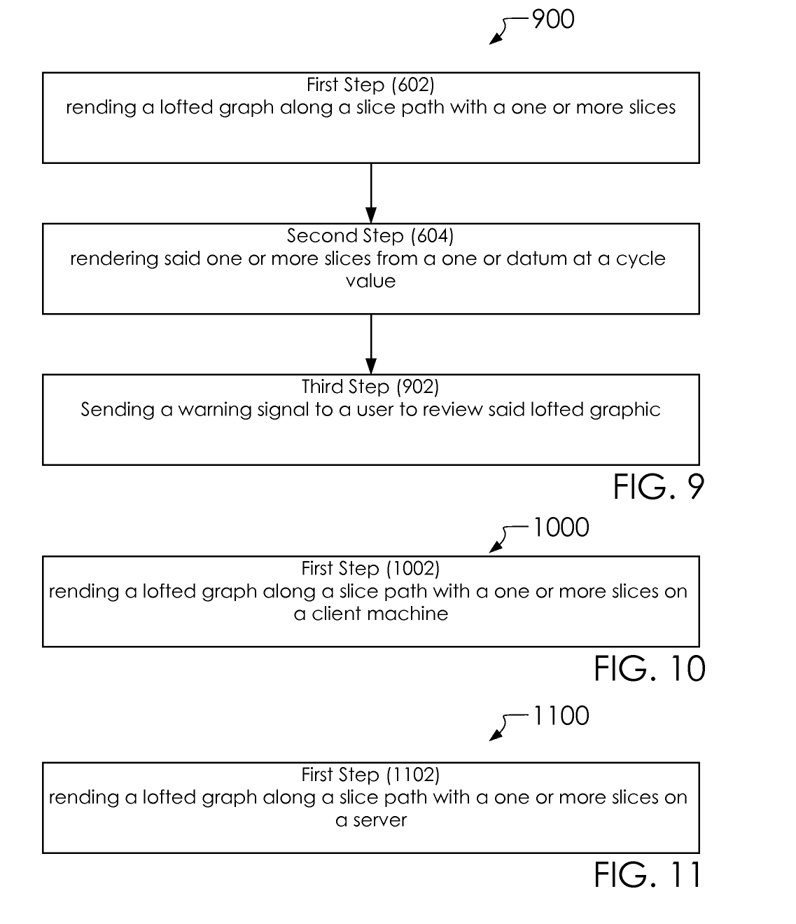

FIG. 9 illustrates a flow diagram 900 comprising said first step 602, said second step 604, and a third step 902. In one embodiment, said third step 902 can comprise sending a warning signal to a user to review said lofted graphic.

FIG. 10 illustrates a flow diagram 1000 comprising said first step 1002. In one embodiment, said first step 1002 can comprise rending a lofted graph along a slice path with a one or more slices on a client machine.

FIG. 11 illustrates a flow diagram 1100 comprising said first step 1102. In one embodiment, said first step 1102 can comprise rending a lofted graph along a slice path with a one or more slices on a server.

In one embodiment, a computer usable medium having a computer readable program code embodied therein, wherein the computer readable program code is adapted to be executed to implement the steps from FIGS. 6-9, and the disclosed system as described above.

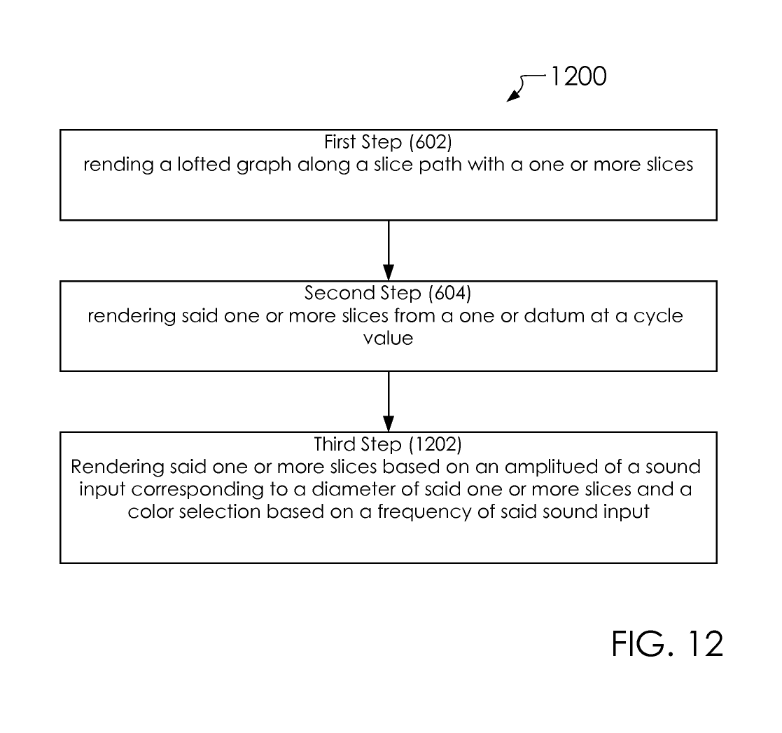

FIG. 12 illustrates a flow diagram 1200 comprising said first step 602, said second step 604, and a third step 1202. In one embodiment, said third step 1202 can comprise rendering said one or more slices based on an amplitude of a sound input corresponding to a diameter of said one or more slices and a color selection based on a frequency of said sound input. For more on this system, please refer to U.S. Pat. No. 8,362,705 B2, filed by one of the co-inventors of the current application.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A graphical system comprising
a lofted graph comprising a one or more slices arranged on a slice path;
said one or more slices connected to one another by lofting them together;
each of said one or more slices separated from one another by a cycle distance;
a one or more period values each associated with a one or more cycle values;
said one or more slices representing a one or more values at said cycle value; and
said one or more values comprising a datum at said cycle value.

2. The graphical system of claim 1 wherein,
said slice path comprises a straight line, and
said lofted graph comprises a linear loft; and further wherein,
said one or more slices are arranged along an axis in a row, and
said one or more slices are rendered as a 3-dimentional object generally having a cylindrical shape.

3. The graphical system of claim 1 wherein,
said slice path comprises a helical path, and
said lofted graph comprises a helical loft; and further wherein,
said one or more slices are arranged along said helical path, and
said one or more slices are rendered as a 3-dimentional object generally having a helical shape.

4. The graphical system of claim 1 wherein,
said one or more slices are rendered from an data input table;
said data input table comprises a one or more datum to be graphically represented; and
said one or more datum comprise, at least, a first value associated with said a period value.

5. The graphical system of claim 4 wherein,
a high-low set of numbers, and
said high-low set of numbers are rendered from said one or more datum.

6. The graphical system of claim 4 wherein,
each of said datum are used to specify a measurement of said graphical system.

7. The graphical system of claim 4 wherein,
said datum are rendered as a one or more radar charts for each of said a period value; and
said one or more slices are rendered from said one or more radar charts.

8. The graphical system of claim 4 wherein,
said one or more slices are circular each having a diameter; and
said datum are rendered as said one or more slices with said diameter corresponding to the values among said datum.

9. The graphical system of claim 4 wherein,
said one or more slices are each a polygon rendered from a one or more radar charts; and
said datum are rendered as said one or more radar charts for each of said a period value.

10. A method of using a graphical system comprising:
rending a lofted graph along a slice path with a one or more slices; and
rendering said one or more slices from a one or datum at a cycle value.

11. The method of claim 10 wherein, rendering said lofted graph along said slice path comprises:
lofting a cycle distance between said one or more slices.

12. The method of claim 11 wherein, lofting said cycle distance between said one or more slices comprises:
arranging said one or more slices along said slice path separated by said cycle distances.

13. The method of claim 12 wherein, said slice path comprises a linear path.

14. The method of claim 12 wherein, said slice path comprises a helical path.

15. The method of claim 10 further comprising:
rendering said one or more slices from a one or more radar charts.

16. The method of claim 10 wherein, rendering said lofted graph is done by a computer.

17. The method of claim 10 further comprising:
collecting said one or more datum with a one or more sensors attached to a network; and
date stamping said cycle value and a period value with a computer when said one or more datum are collected.

18. The method of claim 10 wherein, rendering said lofted graph is done on a client machine.

19. The method of claim 10 wherein, rendering said lofted graph is done on a server.

20. The method of claim 10 further comprising:
sending a warning signal to a user to review said lofted graphic.

21. The method of claim 10 further comprising:
rendering said one or more slices based on an amplitude of a sound input corresponding to a diameter of said one or more slices and a color selection based on a frequency of said sound input.

22. A computer usable medium having a computer readable program code embodied therein, wherein the computer readable program code is adapted to be executed to implement the method of claim 10.
